(19) United States
(12) Patent Application Publication
(10) Pub. No.: US 2011/0312456 A1
(43) Pub. Date: Dec. 22, 2011

(54) Bicycle Sprocket

(76) Inventor: David Earle, Watsonville, CA (US)

(21) Appl. No.: 12/817,835

(22) Filed: Jun. 17, 2010

(51) Int. Cl. F16H 55/30

(52) U.S. Cl. 474/152

(57) ABSTRACT

A bicycle sprocket comprises a sprocket body and a plurality of angularly equidistant teeth extending radially and outwardly from an outer periphery of the sprocket body. The sprocket body has a plurality of bottom edges along the outer periphery. The bottom edges extend in a generally circumferential direction of the sprocket body. Each of the bottom edges is connected between two adjacent ones of the teeth. The central points of the bottom edges include at least first and second groups of the central points. Each of the first group of the central points is spaced apart from the center of the sprocket body by a first distance. Each of the second group of the central points is spaced apart from the center of the sprocket body by a second distance that is smaller than the first distance. The difference between the first and second distances is smaller than 2 mm.

### BACKGROUND OF THE INVENTION

1. Field of the Invention

This invention relates to a bicycle sprocket, and more particularly to a sprocket for a multi-speed bicycle.

2. Description of the Related Art

An elliptical drive sprocket has been used to replace a circular drive sprocket so as to drive a multi-speed bicycle for increasing power output. However, it is difficult to move a bicycle chain between a larger elliptical drive sprocket and a smaller elliptical drive sprocket, thereby resulting in pedaling shock.

### SUMMARY OF THE INVENTION

The object of this invention is to provide a bicycle sprocket that is non-circular and that is configured to allow for smooth and speedy chain shifting.

Accordingly, a bicycle sprocket of this invention comprises a sprocket body and a plurality of angularly equidistant teeth extending radially and outwardly from an outer periphery of the sprocket body. The sprocket body has a plurality of spaced-apart bottom edges along the outer periphery. The bottom edges extend in a generally circumferential direction of the sprocket body. Each of the bottom edges is connected between two adjacent ones of the teeth, and has a central point. The central points of the bottom edges include at least first and second groups of the central points. Each of the first group of the central points is spaced apart from the center of the sprocket body by a first distance. Each of the second group of the central points is spaced apart from the center of the sprocket by a second distance that is smaller than the first distance. The difference between the first and second distances is smaller than 2 mm so as to allow for smooth and speedy chain shifting.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a side view of the preferred embodiment of a bicycle sprocket according to this invention.

### DETAILED DESCRIPTION OF THE PREFERRED EMBODIMENT

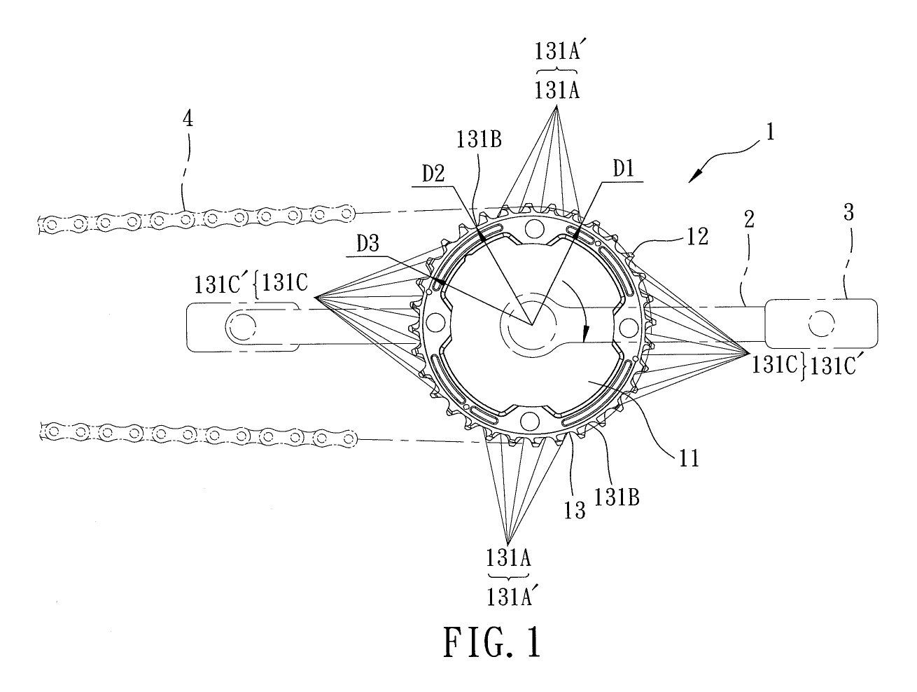

Referring to FIG. 1, the preferred embodiment of a bicycle sprocket 1 according to this invention is configured as a drive sprocket, and is connected to two cranks 2 and two pedals 3 in a known manner for driving a chain 4.

The sprocket 1 includes a sprocket body 11 and a plurality of equidistant teeth 12 extending radially and outwardly from an outer periphery of the sprocket body 11. The sprocket body 11 has a plurality of spaced-apart bottom edges 13 along the outer periphery. The bottom edges 13 extend in a generally circumferential direction of the sprocket body 11. Each of the bottom edges 13 is connected between two adjacent ones of the teeth 12, and has a central point 131A, 131B, 131C.

The central points 131A, 131B, 131C of the bottom edges 13 include a first group of the central points 131A, a second group of the central points 131B, and a third group of the central points 131C. In this embodiment, each of the first and third groups of the central points 131A, 131C consists of two diametrically opposed sub-groups 131A′, 131C′, and the second group of the central points 131B consists of only two diametrically opposed central points 131B.

Each of the first group of the central points 131A is spaced apart from the center of the sprocket body 11 by a first distance D1 of 60.895 mm. Each of the second group of the central points 131B is spaced apart from the center of the sprocket body 11 by a second distance D2 of 60.78 mm. Each of the third group of the central points 131C is spaced apart from the center of the sprocket body 11 by a third distance D3 of 60.785 mm.

Preferably, the difference either between the first and second distances D1, D2 or between the first and third distances D1, D3 is smaller than 2 mm, and the difference between the second and third distances D2, D3 is smaller than 0.1 mm.

As illustrated, when each of the cranks 2 is in a horizontal position, one of the sub-groups 131A′ of the first group of the central points 131A is disposed under the other of the sub-groups 131A′ of the first group of the central points 131A. In this condition, through operation of a derailleur (not shown), the chain 4 can be moved easily between a larger sprocket 1 and a smaller sprocket 1, thereby resulting in smooth and speedy chain shifting. Thus, the object of this invention is achieved.

With this invention thus explained, it is apparent that numerous modifications and variations can be made without departing from the scope and spirit of this invention. It is therefore intended that this invention be limited only as indicated by the appended claims.

I claim:

1. A bicycle sprocket comprising a sprocket body and a plurality of angularly equidistant teeth extending radially and outwardly from an outer periphery of said sprocket body, said sprocket body having a plurality of spaced-apart bottom edges along the outer periphery, said bottom edges extending in a generally circumferential direction of said sprocket body, each of said bottom edges being connected between two adjacent ones of said teeth and having a central point, said central points of said bottom edges including at least first and second groups of said central points, each of said first group of said central points being spaced apart from a center of said sprocket body by a first distance, each of said second group of said central points being spaced apart from the center of said sprocket body by a second distance that is smaller than the first distance, a difference between the first and second distances being smaller than 2 mm.

2. The bicycle sprocket as claimed in claim 1, configured as a drive sprocket connected to two cranks, wherein said central points of said bottom edges further include a third group of said central points, each of which are spaced apart from the center of said sprocket body by a third distance that is smaller than the first distance and greater than the second distance, a difference between the first and third distances being smaller than 2 mm, a difference between the second and third distances being smaller than 0.1 mm.

3. The bicycle sprocket as claimed in claim 2, wherein said first group of said central points include two diametrically opposed sub-groups of said central points, one of said sub-groups being disposed under the other of said sub-groups when each of the cranks is disposed at a horizontal position.

4. A bicycle sprocket comprising a sprocket body and a plurality of angularly equidistant teeth extending radially and outwardly from an outer periphery of said sprocket body, said sprocket body having a plurality of spaced-apart bottom edges along the outer periphery, said bottom edges extending in a generally circumferential direction of said sprocket body, each of said bottom edges being connected between two adjacent ones of said teeth and having a central point, at least two of said central points of said bottom edges being spaced apart from a center of said sprocket body by different distances so as to promote shift performance.
